(19) United States
(12) Patent Application Publication
(10) Pub. No.: US 2007/0098598 A1
(43) Pub. Date: May 3, 2007

(54) In-line automated fluid dilution

(76) Inventors: Michael Ahern, Mountain View, CA (US); Jimmy K. Dzuong, San Jose, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/263,155

(22) Filed: Oct. 31, 2005

(51) Int. Cl. B01L 3/02

(52) U.S. Cl. 422/100

(57) ABSTRACT

A system and method for fluid dilution is provided, in one example to be used in conjunction with a chemical analysis tool. In one embodiment, a fluid dilution system includes a supply reservoir including a concentrated fluid, a diluent source including a diluent, and a diluted fluid reservoir operably coupled to the supply reservoir and the diluent source. A fluid level sensor is operably coupled to the diluted fluid reservoir, a pump is operably coupled between the supply reservoir and the diluted fluid reservoir, and a controller is configured to engage the pump based upon signals from the fluid level sensor to pump desired amounts of the concentrated fluid for providing a diluted fluid in the diluted fluid reservoir.

### TECHNICAL FIELD

The present invention relates generally to fluid dilution and, more particularly, to a system and method for precise dilution of fluids related to in-line automated chemical analysis.

### BACKGROUND

Automated systems for measuring the concentration of analytes in a sample have been developed using a number of analytical techniques such as ion chromatography or mass spectrometry. In particular, mass spectrometry is often the technique of choice to achieve sensitivity of parts per billion (ppb) or sub-ppb such as parts per trillion (ppt). For example, commonly assigned U.S. patent application Ser. Nos. 10/641,480, 10/094,394, 10/086,025, and 10/004,627 disclose automated analytical apparatuses that measure contaminants present in trace concentrations or liquid bath constituents and are incorporated by reference herein for all purposes.

Such automated analytical apparatuses require the use of dilute fluids (e.g., 1% nitric acid) for internal processes and for cleaning component parts between samples or for certain operations such as maintenance. Examples of these component parts include sample preparation apparatus, fluid lines and tubing, pumps, syringes, mixers, and reservoirs. It is noted that the common dilution agent, ultrapure water (UPW), is commonly part of the available piped in fluids in many manufacturing areas and particularly in semiconductor manufacturing plants.

In some cases relatively large volumes of dilute acids or other liquid media are required resulting in the need for large reservoirs located at or in the automated analytical tool and/or frequent replenishment of these reservoirs, e.g., >1 liter of dilute nitric acid is required per day for the tools incorporating the inventions referenced above.

It is expected that in-line analytical or metrology instrumentation used to monitor and control industrial processes will have minimal routine maintenance requirements. In semiconductor manufacturing applications, clean-room space is costly and storing long term supplies of diluted reagents next to an analytical tool may be impractical. Many of the desirable reagents are hazardous. Anything that reduces the volume of hazardous material and the potential exposure of personnel to hazardous materials is desirable.

Diluted reagents used for sample preparation processes or to clean contamination in analytical systems used to detect contamination levels, must have very low contamination levels down to the parts per trillion range. Thus any inadvertent contamination by personnel or the environment degrade analytical results. By having an automated in-situ dilution capability, strong reagents stored in or near to the analytical tool can be prepared at necessary concentrations as they are needed. Elimination of the need for an operator reduces the likelihood of errors and reduces the danger of introducing environmental contamination.

Thus, a system and method for providing in-line automated fluid dilution for use with in-line automated analytical tools is highly desirable to improve productivity and the quality of measurements, to reduce storage requirements, and to reduce costs and to reduce maintenance requirements.

### SUMMARY

The present invention provides a system and method for in-line automated fluid dilution to be used in conjunction with a chemical analysis tool.

In accordance with the present invention, an automated in-line fluid dilution system is provided. The system includes at least one supply reservoir containing a concentrated fluid. The system also includes a diluent source which provides a source of the diluent fluid. Normally this is ultrapure water that is commonly available in manufacturing areas as in the case of the semiconductor industry. The system further includes a diluted fluid reservoir operably connected through pumps, a fluid control device connected to the concentrated fluid reservoir(s), and the diluent source, respectively.

In accordance with an embodiment of the present invention, an automated in-line fluid dilution system is provided, the system including a supply reservoir containing a concentrated fluid, a diluent source including a diluent, a valve to control the supply of diluent, and a diluted fluid reservoir operably coupled to the supply reservoir and the diluent source. The system further includes a fluid level sensor operably coupled to the diluted fluid reservoir, a pump operably coupled between the supply reservoir and the diluted fluid reservoir, and a controller configured to engage the pump based upon signals from the fluid level sensor to pump desired amounts of the concentrated fluid for providing a diluted fluid in the diluted fluid reservoir, said controller also controlling the diluent valve.

In accordance with another embodiment of the present invention, an automated in-line fluid dilution system is provided, the system including a supply reservoir including a concentrated fluid, a diluent source including a diluent, a diluted fluid reservoir for holding a diluted fluid, a first fluid level sensor for sensing a high fluid level in the diluted fluid reservoir, and a second fluid level sensor for sensing a low fluid level in the diluted fluid reservoir. The system further includes a pump operably coupled to the supply reservoir, the diluent source, and the diluted fluid reservoir for metering the concentrated fluid and the diluent into a single fluid stream to be delivered to the diluted fluid reservoir. A controller is configured to engage the pump based upon signals from the first and second fluid level sensors.

In accordance with yet another embodiment of the present invention, a method of automated in-line fluid dilution is provided, the method comprising signaling a low fluid level in a diluted fluid reservoir, pumping a concentrated fluid into the diluted fluid reservoir, flowing a diluent into the diluted fluid reservoir until a high fluid level is signaled, thereby providing a diluted fluid in the diluted fluid reservoir, and flowing the diluted fluid to a chemical analysis tool.

In accordance with yet another embodiment of the present invention, a method of automated in-line fluid dilution is provided, the method comprising signaling a low fluid level in a diluted fluid reservoir, metering a concentrated fluid and a diluent into a single fluid stream, pumping the single fluid stream into the diluted fluid reservoir until a high fluid level is signaled, and flowing the diluted fluid to a chemical analysis tool. This embodiment lends itself to providing on demand, diluted reagents as required and can be controlled by a computer or microprocessor including the one that also controls a fully automated metrology tool or a manually controlled analytical instrument designed for laboratory use.

Advantageously, the present invention provides an efficient and automated system and method of bulk fluid dilution for use in various environments, including but not limited to chemical analysis tools and laboratory settings.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows a diagram of an automated fluid dilution system for automated in-line chemical analysis in accordance with an embodiment of the present invention.

FIG. 2 shows a flowchart of automated fluid dilution in accordance with an embodiment of the present invention.

FIG. 3 shows a diagram of another automated fluid dilution system for automated in-line chemical analysis in accordance with another embodiment of the present invention.

FIG. 4 shows a flowchart of automated fluid dilution in accordance with another embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

The present invention provides a system and method for automated and in-line fluid dilution related to an automated in-line chemical analysis system. The fluid to be diluted may be one of various fluids, including but not limited to acids (e.g., nitric, sulfuric, hydrochloric), bases, oxidants, reducing reagents, solvents (such as alcohols, esters, ethers, glycols, ketones, amides, amines, or their mixtures), cleaning solutions, photoresists, strippers, developers, mixtures thereof, and other liquids.

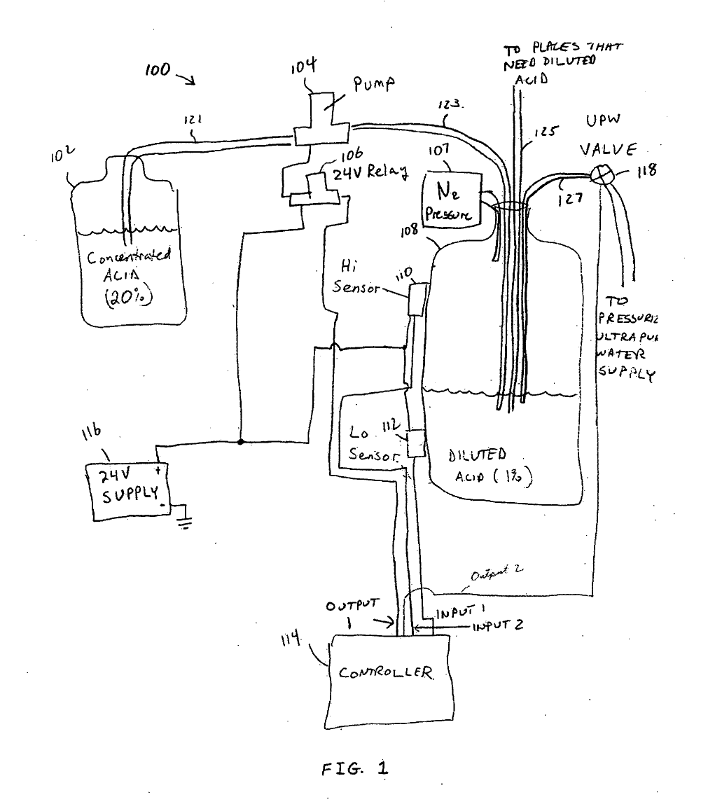

FIG. 1 shows a diagram of an in-line automated fluid dilution system 100 used in conjunction with an in-line and automated chemical analysis apparatus in accordance with an embodiment of the present invention. Fluid dilution system 100 includes a concentrated fluid reservoir 102, a pump 104, a diluted fluid reservoir 108, a first sensor 110, a second sensor 112, and a controller 114. A power supply 116 is operably coupled to sensors 110 and 112 and a relay 106, which is operably coupled to pump 104. Fluid lines 121, 123, 125, and 127 are pathways for different fluids as will be described below.

Concentrated fluid reservoir 102 is a vessel compatible with various solutions, such as acidic solutions, and may be capable of being pressurized. In one example, with no intent to limit the invention thereby, fluid reservoir 102 is made of Kel-F or Teflon material to provide compatibility with various solutions without leaching of contaminants. However, various reservoirs are applicable such as those that provide storage ability with sufficient venting capability, compatibility with various solutions, and cleanliness.

It is noted that lines transporting fluids may comprise piping, fittings, and/or tubing in one example, but any applicable material and structure that allows for the accurate transfer of liquids may be used to operably connect to valves, syringes, reservoirs, and other apparatus in accordance with the present invention. In one example, with no intent to limit the invention thereby, components are connected with tubing made of Teflon® PFA 450 HP fluoropolymer, having 0.062″ O.D.×0.016″ I.D., Part #106-0062016, available from Parker Hannifin of Cleveland, Ohio.

Pump 104 is operably coupled between concentrated fluid reservoir 102 and diluted fluid reservoir 108. Pump 104 is also operably coupled to relay 106, which is operably coupled to power supply 116 and controller 114. Pump 104 provides concentrated fluid from concentrated fluid reservoir 102 to diluted fluid reservoir 108 via fluid lines 121 and 123 under the control of controller 114. In one example, with no intent to limit the invention thereby, pump 104 is a valve pump 15OSP available from Bio-Chem Valve Inc. of Boonton, N.J.

Diluted fluid reservoir 108 is operably coupled to pump 104 via fluid line 123, a diluent source via fluid line 127 and valve 118 (or other fluid control device; e.g., a pump, or a mass flow controller), an apparatus requiring diluted fluid via fluid line 125, and a gas source 107 to pressurize the diluted fluid in reservoir 108 for future transport of the diluted fluid to other apparatus as needed. Diluted fluid reservoir 108 is a vessel compatible with various solutions, such as acidic solutions, and may be capable of being pressurized. In one example, with no intent to limit the invention thereby, fluid reservoir 108 is made of Kel-F or Teflon material to provide compatibility with various solutions without leaching of contaminants. However, various reservoirs are applicable such as those that provide storage ability with sufficient venting capability, compatibility with various solutions, and cleanliness.

First and second sensors 110 and 112 detect a fluid level, and in this embodiment detect when diluted fluid reservoir 108 is “full” and “empty”, respectively. In one example, with no intent to limit the invention thereby, sensors 110 and 112 are each capacitive sensors, part number 2-101937, available from E&M Electric of Healdsburg, Calif.

Controller 114 is operably coupled to relay 106 and sensors 110 and 112 and includes automation logic for controlling operation of pump 104 and diluent valve 118 while reading signals from sensors 110 and 112. In one embodiment, controller 114 may be used to mix desired volumes of concentrated fluid and diluent to provide diluted fluids at desired concentrations. In one example, with no intent to limit the invention thereby, controller 114 is a “MicroLYNX-4” controller available from Intelligent Motion Systems, Inc. of Marlborough, Connecticut.

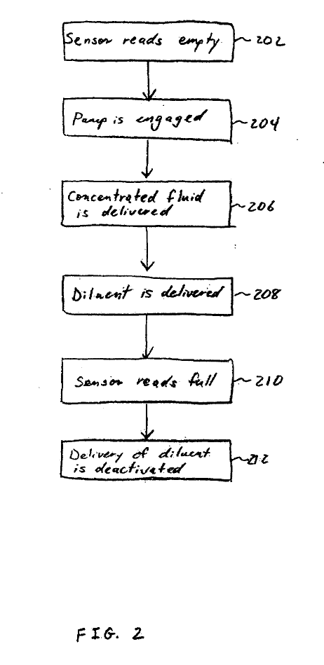

Referring now to FIG. 2 in conjunction with FIG. 1, a method of automated fluid dilution is shown in accordance with an embodiment of the present invention. At step 202, sensor 112 detects a low (“empty”) level of diluted fluid in reservoir 108 and sends a signal to controller 114. At step 204, controller 114 engages pump 104 via relay 106, and at step 206, pump 104 pulls and pumps concentrated fluid from reservoir 102 to reservoir 108 until stopped by controller 114. Controller 114 may control the amount of concentrated fluid delivered to reservoir 108 based upon a time parameter, a pump stroke parameter, or both, in conjunction with a volume of diluent parameter based upon the desired dilution of the concentrated fluid. Accordingly, at step 208, controller 114 engages diluent valve 118 to flow a diluent (e.g., ultra pure water (UPW) from a pressurized UPW supply) into reservoir 108 via fluid line 127 until sensor 110 senses a fluid level and sends a signal to controller 114 indicating that diluent flow should be stopped, as shown at steps 210 and 212. The diluted fluid in reservoir 108 may then be delivered to parts of the analysis tool requiring the diluted fluid via fluid line 125.

In one example, a 20% concentration of nitric acid may be diluted to a 1% concentration of nitric acid. 20% concentrated nitric acid is provided in a reservoir 102. When sensor 112, reading about every 2 seconds, detects a low level of diluted acid in reservoir 108, sensor 112 sends a signal to controller 114 (either a 1 or 0). Controller 114 then engages pump 104 to provide about 50 ml of concentrated nitric acid in a 1 L reservoir 108 (pump 104 may be engaged for about 200 strokes when pump 104 pulls about 0.25 ml/pump stroke, which may take about 1 minute). After about 50 ml of concentrated nitric acid is provided within reservoir 108, controller 114 engages diluent valve 118 to provide UPW until a signal from sensor 110 tells controller 114 to disengage diluent valve 118, thereby “filling” reservoir 108 to about 1 L. Accordingly, 20% concentrated nitric acid will have been diluted to about 1% concentrated nitric acid.

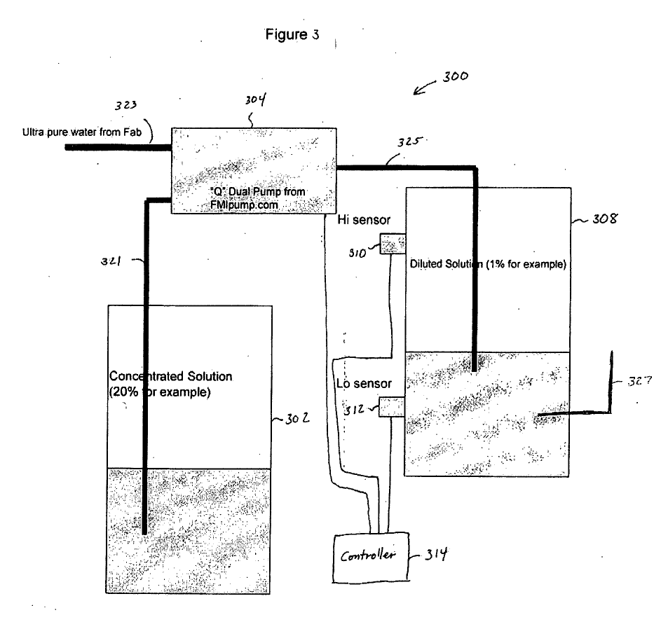

Referring now to FIG. 3, a diagram of an automated fluid dilution system for automated in-line chemical analysis in accordance with another embodiment of the present invention is shown. Similar to fluid dilution system 100 of FIG. 1, fluid dilution system 300 includes a concentrated fluid reservoir 302, a diluted fluid reservoir 308, a first sensor 310, a second sensor 312, and a controller 314. A power supply (not shown) is operably coupled to sensors 310 and 312. Fluid lines 321, 323, 325, and 327 are pathways for different fluids as will be described below.

Similar to concentrated fluid reservoir 102, concentrated fluid reservoir 302 is a vessel compatible with various solutions, such as acidic solutions, and may be capable of being pressurized. In one example, with no intent to limit the invention thereby, fluid reservoir 302 is made of Kel-F or Teflon material to provide compatibility with various solutions without leaching of contaminants. However, various reservoirs are applicable such as those that provide storage ability with sufficient venting capability, compatibility with various solutions, and cleanliness.

It is noted that lines transporting fluids may comprise piping, fittings, and/or tubing in one example, but any applicable material and structure that allows for the accurate transfer of liquids may be used to operably connect to valves, syringes, reservoirs, and other apparatus in accordance with the present invention. In one example, with no intent to limit the invention thereby, components are connected with tubing made of Teflon® PFA 450 HP fluoropolymer, having 0.062″ O.D.×0.016″ I.D., Part #106-0062016, available from Parker Hannifin of Cleveland, Ohio.

Diluted fluid reservoir 308 is similar to diluted fluid reservoir 108 in function but is operably coupled to pump 304 via fluid line 325 for receiving a diluted fluid. Diluted fluid reservoir 308 is a vessel compatible with various solutions, such as acidic solutions, and may be capable of being pressurized. In one example, with no intent to limit the invention thereby, fluid reservoir 308 is made of Kel-F or Teflon material to provide compatibility with various solutions without leaching of contaminants. However, various reservoirs are applicable such as those that provide storage ability with sufficient venting capability, compatibility with various solutions, and cleanliness.

Similar to first and second sensors 110 and 112, first and second sensors 310 and 312 detect a fluid level, and in this embodiment detect when diluted fluid reservoir 308 is “full” and “empty”, respectively. In one example, with no intent to limit the invention thereby, sensors 310 and 312 are each capacitive sensors,. part number 2-101937, available from E&M Electric of Healdsburg, Calif.

The full signal from sensor 310 can signal the completion of the filling process. Alternatively, if pump 304 has a fixed volume per stroke, filling of the reservoir is determined by counting the number of strokes. Sensor 310 in this case can then provide an overfill signal alerting personnel of the need for maintenance.

Pump 304 is operably coupled to concentrated fluid reservoir 302, a UPW supply, and diluted fluid reservoir 308 via lines 321, 323, and 325, respectively, for directly pumping a mixture of concentrated fluid and UPW (i.e., diluted fluid) to diluted fluid reservoir 308 under the control of controller 314. A variety of pumps may be used for proportional metering (e.g., 20:1) of two fluids (e.g., diluent and concentrated solution) into a single fluid stream (e.g., diluted fluid). In one example, with no intent to limit the invention thereby, pump 304 is a “Q” dual pump available from Fluid Metering, Inc. of Long Island, N.Y.

Controller 314 is operably coupled to sensors 310 and 312 and includes automation logic for controlling operation of pump 304 while reading signals from sensors 310 and 312. In one example, with no intent to limit the invention thereby, controller 314 is a “MicroLYNX-4” controller available from Intelligent Motion Systems, Inc. of Marlborough, Conn.

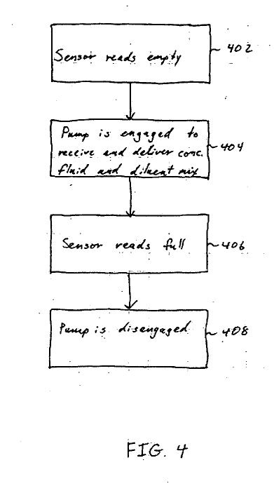

Referring now to FIG. 4 in conjunction with FIG. 3, a flowchart of automated fluid dilution is shown in accordance with another embodiment of the present invention. At step 402, sensor 312 detects a low (“empty”) level of diluted fluid in reservoir 308 and sends a signal to controller 314. At step 404, controller 314 engages pump 304 to pull and pump a mixture of concentrated fluid from reservoir 302 and diluent to reservoir 308 until stopped by controller 314. At step 406, sensor 310 senses a fluid level and sends a signal to controller 314 indicating that reservoir 308 is full, and at step 408, controller 314 disengages pump 304 until step 402 occurs again. The diluted fluid in reservoir 308 may then be delivered to parts of the analysis tool requiring the diluted fluid via fluid line 327.

Advantageously, the present invention provides an efficient and automated system and method of bulk fluid dilution for use in conjunction with automated and in-line chemical analysis tools. In one example, the present invention may be used with “TCM” and “CCM” automated chemical analysis apparatus available from Metara, Inc. of Sunnyvale, Calif. Other areas of application include but are not limited to general automated fluid dilution required in laboratory or bench settings.

Embodiments described above illustrate but do not limit the invention. It should also be understood that numerous modifications and variations are possible in accordance with the principles of the present invention. For example, various types and sizes of reservoirs, types of fluids, and dilution ratios are within the scope of the present invention. Furthermore, diluted mixtures having more than two components are within the scope of the present invention. Accordingly, the scope of the invention is defined only by the following claims.

We claim:

1. An automated in-line fluid dilution system, comprising:
at least one supply reservoir including a concentrated fluid;
a diluent source including a diluent;
a diluted fluid reservoir operably coupled to the supply reservoir and the diluent source;
at least one fluid level sensor operably coupled to the diluted fluid reservoir;
a pump operably coupled between the supply reservoir and the diluted fluid reservoir;
a fluid control device operably coupled between the diluent source and the diluted fluid reservoir; and
a controller configured to engage the pump based upon signals from the fluid level sensor to pump desired amounts of the concentrated fluid, the controller additionally configured to control the fluid control device, for providing a diluted fluid in the diluted fluid reservoir.

2. The system of claim 1 where the dilution operation is controlled by a microprocessor or computer that may also control the analytical instrument.

3. The system of claim 1, wherein the at least one fluid level sensor includes a first capacitive sensor for sensing a high fluid level in the diluted fluid reservoir and a second capacitive sensor for sensing a low fluid level in the diluted fluid reservoir.

4. The system of claim 1, wherein the concentrated fluid is selected from the group consisting of nitric acid, ammonium hydroxide, acetic acid, hydrofluoric acid, sodium hydroxide, sulfuric acid, and mixtures thereof.

5. The system of claim 1, where the diluent is ultra pure water.

6. The system of claim 1, wherein the pump is operably coupled between the diluent source and the diluted fluid reservoir.

7. The system of claim 1, wherein the pump meters the concentrated fluid and the diluent into a single fluid stream to be delivered to the diluted fluid reservoir.

8. The system of claim 1, wherein the diluent source is coupled to the diluted fluid reservoir through a valve.

9. The system of claim 1, further comprising a gas source operably coupled to the diluted fluid reservoir for pressurizing the diluted fluid reservoir.

10. The system of claim 1, further comprising:
a relay operably coupled between the pump and the controller; and
a power supply operably coupled to the relay and the fluid level sensor.

11. The system of claim 1, further comprising a chemical analysis tool operably coupled to the diluted fluid reservoir for receiving a portion of the diluted fluid.

12. The system of claim 1, further comprising a diluent valve operably coupled between the diluted fluid reservoir and the diluent source.

13. An automated in-line fluid dilution system, comprising:
a supply reservoir including a concentrated fluid;
a diluent source including a diluent;
a diluted fluid reservoir for holding a diluted fluid;
a first fluid level sensor for sensing a high fluid level in the diluted fluid reservoir;
a second fluid level sensor for sensing a low fluid level in the diluted fluid reservoir;
a pump operably coupled to the supply reservoir, the diluent source, and the diluted fluid reservoir for metering the concentrated fluid and the diluent into a single fluid stream to be delivered to the diluted fluid reservoir; and
a controller configured to engage the pump based upon signals from the first and second fluid level sensors.

14. The system of claim 13 where the dilution operation is controlled by a microprocessor or computer that may also control the analytical instrument.

15. The system of claim 13, wherein the concentrated fluid is selected from the group consisting of nitric acid, ammonium hydroxide, acetic acid, hydrofluoric acid, sodium hydroxide, sulfuric acid, and mixtures thereof.

16. The system of claim 13, where the diluent is ultra pure water.

17. The system of claim 13, wherein the pump meters the concentrated fluid and the diluent into a single fluid stream to be delivered to the diluted fluid reservoir.

18. The system of claim 13, wherein the first fluid level sensor is a capacitive sensor for sensing a high fluid level in the diluted fluid reservoir.

19. The system of claim 13, wherein the second fluid level sensor is a capacitive sensor for sensing a low fluid level in the diluted fluid reservoir.

20. The system of claim 13, further comprising a gas source operably coupled to the diluted fluid reservoir for pressurizing the diluted fluid reservoir.

21. The system of claim 13, further comprising:
a stepper motor operably coupled between the pump and the controller; and
a power supply operably coupled to the first fluid level sensor and the second fluid level sensor.

22. The system of claim 13, further comprising a chemical analysis tool operably coupled to the diluted fluid reservoir for receiving a portion of the diluted fluid.

23. A method of automated in-line fluid dilution, the method comprising:
signaling a low fluid level in a diluted fluid reservoir;
pumping a concentrated fluid into the diluted fluid reservoir;
flowing a diluent into the diluted fluid reservoir until a high fluid level is signaled, thereby providing a diluted fluid in the diluted fluid reservoir; and
flowing the diluted fluid to a chemical analysis tool.

24. The method of claim 23, wherein the diluted fluid is flowed to a chemical analysis tool via pressurized gas.

25. The method of claim 23, wherein the concentrated fluid is selected from the group nitric acid, ammonium hydroxide, acetic acid, hydrofluoric acid, sodium hydroxide, and sulfuric acid, and the diluent is ultra pure water.

26. A method of automated in-line fluid dilution, the method comprising:
signaling a low fluid level in a diluted fluid reservoir;
pumping a concentrated fluid and a diluent into a single fluid stream until a high fluid level is signaled; and
flowing the diluted fluid to a chemical analysis tool.

27. The method of claim 26, wherein the diluted fluid is flowed to a chemical analysis tool via pressurized gas.

28. The method of claim 26, wherein a high fluid level is signaled by a sensor.

29. The method of claim 26, wherein a high fluid level is signaled by counting the number of strokes of the pump.

30. The method of claim 26, wherein the concentrated fluid is selected from the group consisting of nitric acid, ammonium hydroxide, acetic acid, hydrofluoric acid, sodium hydroxide, sulfuric acid, and mixtures thereof, and the diluent is ultra pure water.
